(19) United States
(12) Patent Application Publication
(10) Pub. No.: US 2020/0137782 A1
(43) Pub. Date: Apr. 30, 2020

(54) DATA TRANSMISSION METHOD, ACCESS NETWORK DEVICE, AND TERMINAL DEVICE

(71) Applicant: HUAWEI TECHNOLOGIES CO., LTD., Shenzhen (CN)

(72) Inventors: Hongjia SU, Shanghai (CN); Jun ZHU, Shenzhen (CN); Jiyong PANG, Shanghai (CN)

(21) Appl. No.: 16/725,889

(22) Filed: Dec. 23, 2019

Related U.S. Application Data
(63) Continuation of application No. PCT/CN2018/092800, filed on Jun. 26, 2018.

(30) Foreign Application Priority Data
Jun. 30, 2017 (CN) 201710522431.8

(51) Int. Cl. H04W 72/12; H04W 72/04; H04L 1/00

(52) U.S. Cl. CPC H04W 72/1273; H04W 72/042; H04W 92/18; H04L 1/0004; H04W 72/0466

(57) ABSTRACT

This application provides a data transmission method, an access network device, and a terminal device. The method includes: sending, by an access network device, first control information to a first terminal device, where the first control information is used to instruct the first terminal device to transmit downlink data received from the access network device to a second terminal device a plurality of times through a sidelink; and sending, by the access network device, the downlink data to the first terminal device. The method in this application increases a probability of correctly receiving the downlink data by the second terminal device, and is not limited to being affected by an uplink and downlink configuration of the access network device.

### CROSS-REFERENCE TO RELATED APPLICATIONS

This application is a continuation of International Application No. PCT/CN2018/092800, filed on Jun. 26, 2018, which claims priority to Chinese Patent Application No. 201710522431.8, filed on Jun. 30, 2017. The disclosures of the aforementioned applications are hereby incorporated by reference in their entireties.

### TECHNICAL FIELD

This application relates to communications technologies, and in particular, to a data transmission method, an access network device, and a terminal device.

### BACKGROUND

Ultra-reliable and low latency communications (URLLC) is a most important application scenario of a 5G mobile communications system. Low latency and high stability are two most important features of the URLLC. A requirement of the URLLC for stability is 1 to 10⁻⁵, increased a lot compared with 1 to 10⁻² of LTE. In some application scenarios, a requirement for an end-to-end latency is even less than 1 ms. If URLLC transmission is performed by using a traditional long term evolution (LTE), a requirement of a URLLC service cannot be satisfied. Therefore, a currently commonly used solution is transmitting downlink URLLC data a plurality of consecutive times. As shown in FIG. 1, the method can increase a probability of receiving the downlink URLLC data by an edge device (for example, a transmit end sends data of a same version or data of different retransmission versions a plurality of times, so that a receive end can be enabled to perform a combined process, to increase the correctly receiving probability), and can further reduce a related latency brought by an application hybrid automatic repeat request (HARQ) scheme by relying on the plurality of transmissions without requiring an acknowledgement (ACK) or negative acknowledge (NACK) feedback, thereby satisfying a latency requirement of the URLLC scenario.

However, in a time division duplex (TDD) mode, because a base station has completed an uplink and downlink configuration in advance, a terminal device performs downlink receiving and uplink sending based on a ratio of an uplink slot to a downlink slot that has been configured by a network side device. If the network side device sends the downlink URLLC data at the last downlink position (DL slot) of the uplink and downlink configuration, the network side device has only one DL slot for sending the downlink URLLC data, and has no additional DL slot for transmitting the downlink URLLC data a plurality of consecutive times. Therefore, in this scenario, the solution in the prior art cannot improve the probability of receiving the URLLC data by the terminal device.

### SUMMARY

This application provides a data transmission method, an access network device, and a terminal device, to resolve a technical problem in the prior art that when there is no additional DL slot for transmitting downlink URLLC data a plurality of consecutive times, a probability of correctly receiving the URLLC data by the terminal device cannot be increased.

According to a first aspect, this application provides a data transmission method, including:

sending, by an access network device, first control information to a first terminal device, where the first control information is used to instruct the first terminal device to transmit downlink data received from the access network device, to a second terminal device a plurality of times through a sidelink (SL); and

sending, by the access network device, the downlink data to the first terminal device.

In the method provided in the first aspect, the access network device sends the first control information to the first terminal device, so that the first terminal device transmits the downlink data received from the access network device, to the second terminal device the plurality of times through the sidelink based on the first control information, thereby increasing a probability of correctly receiving the downlink data by the second terminal device, and the plurality of transmissions through the sidelink is not limited to being affected by an uplink and downlink configuration of the access network device. When the downlink data is downlink URLLC data, the method in this application further improves reliability of the URLLC data and ensures a low latency requirement of a data transmission in a URLLC scenario.

In one embodiment, the first control information includes a coordinated transmission instruction, first resource information, and second resource information; and

the coordinated transmission instruction is used to instruct the first terminal device to transmit the downlink data received by the first terminal device based on the first resource information, to the second terminal device the plurality of times through the sidelink based on the second resource information.

In the method provided in one embodiment, the first terminal device may obtain, by using the definite coordinated transmission instruction, whether coordinated transmission (in one embodiment, transmitting the data to the second terminal device through the sidelink the plurality of times) needs to be performed by the first terminal device, and a resource used for the coordinated transmission is clarified, ensuring accuracy of the coordinated transmission performed by the first terminal device.

In one embodiment, the method further includes:

forming, by the access network device, the second resource information based on a to-be-cancelled uplink scheduling resource.

In one embodiment, the method further includes:

sending, by the access network device, second control information to a terminal device in a coverage area of the access network device, where the second control information carries an uplink scheduling cancellation instruction, and the uplink scheduling cancellation instruction is used to instruct the access network device to cancel the uplink scheduling resource of the terminal device.

In one embodiment, the method further includes:

forming, by the access network device, the second resource information based on a new uplink resource allocated by the access network device for the second terminal device, where the new uplink resource is different from an uplink resource that has been scheduled by the access network device.

In the method provided in the foregoing embodiments, the access network device may form the second resource information by allocating the new uplink resource for the data transmission through the sidelink, to assist the first terminal device in transmitting the received downlink data to the second terminal device the plurality of times. The access network device may alternatively cancel the uplink scheduling resource that has been scheduled and that is of the terminal device, and use the cancelled uplink scheduling resource as a resource of the data transmission through the sidelink, to assist the first terminal device in transmitting the received downlink data to the second terminal device the plurality of times. Therefore, the method can be not limited to being affected by the uplink and downlink configuration used by the access network device, and can increase the probability of correctly receiving the downlink data by the second terminal device, improve network quality of service of the second terminal device, and ensure stability and reliability of the data transmission.

In one embodiment, the first control information is downlink control information (DCI) scrambled by the access network device by using a group identifier of a terminal device group or an identifier of the second terminal device; and the terminal device group includes the first terminal device and the second terminal device.

In the method provided in this embodiment, the first control information is obtained by scrambling the DCI (the DCI is a DCI format X in the following embodiments) by using the identifier of the terminal device group or the identifier of the second terminal device, so that the first terminal device can correctly receive the first control information, avoiding a case in which the first terminal device receives control information from another terminal device by mistake.

In one embodiment, the second control information is downlink control information (DCI) scrambled by the access network device by using a group identifier of a terminal device group or an identifier of the terminal device; and the terminal device group includes the first terminal device and the second terminal device.

In the method provided in this embodiment, the first control information is obtained by scrambling the DCI (the DCI is a DCI format Y in the following embodiments) by using the identifier of the terminal device group or the identifier of the terminal device covered by the access network device, so that the terminal device can correctly receive the second control information, avoiding a case in which the terminal device receives control information from another terminal device by mistake.

According to a second aspect, this application provides a data transmission method, including:

receiving, by a first terminal device, first control information sent by an access network device; and

transmitting, by the first terminal device, downlink data received by the first terminal device from the access network device, to a second terminal device a plurality of times through a sidelink based on the first control information.

In one embodiment, the first control information includes a coordinated transmission instruction, first resource information, and second resource information, and the transmitting, by the first terminal device, downlink data received by the first terminal device from the access network device, to a second terminal device a plurality of times through a sidelink based on the first control information includes:

receiving, by the first terminal device based on the first resource information, the downlink data sent by the access network device; and

transmitting, by the first terminal device based on the coordinated transmission instruction and the second resource information, the downlink data to the second terminal device through the sidelink the plurality of times.

In one embodiment, the second resource information is information formed by the access network device based on a to-be-cancelled uplink scheduling resource.

In one embodiment, the second resource information is information formed by the access network device based on a new uplink resource allocated by the access network device for the second terminal device, and the new uplink resource is different from an uplink resource that has been scheduled by the access network device.

For beneficial effects of the method provided in the second aspect and the embodiments in the second aspect, refer to the beneficial effects brought by the method provided in the first aspect and the embodiments in the first aspect, and details are not described herein again.

With reference to the first aspect and the second aspect, in one embodiment, the second resource information includes first time-frequency resource configuration information and first transmission configuration information that are used when the first terminal device sends the downlink data to the second terminal device the plurality of times; and

the first transmission configuration information includes at least one of a modulation and coding scheme (MCS) parameter, antenna configuration information, a quantity of transmissions, and version number-related information for a data retransmission that are used when the first terminal device sends the downlink data to the second terminal device.

In the method provided in this embodiment, the first terminal device may clearly learn, through content included in the second resource information, how to transmit the downlink data to the second terminal device through the sidelink the plurality of times, ensuring accuracy of the transmission through the sidelink and improving transmission efficiency.

In one embodiment, the first resource information includes second time-frequency resource configuration information and second transmission configuration information that are used when the first terminal device receives the downlink data; and

the second transmission configuration information includes at least one of a modulation and coding scheme (MCS) related parameter and antenna configuration information that are used when the first terminal device receives the downlink data.

In the method provided in this embodiment, the first terminal device may clearly learn, through content included in the first resource information, how to receive the downlink data delivered by the access network device, ensuring accuracy of receiving the downlink data.

According to a third aspect, this application provides an access network device, including units or means configured to perform the operations in the first aspect.

According to a fourth aspect, this application provides a terminal device, including units or means configured to perform the operations in the second aspect.

According to a fifth aspect, this application provides an access network device, including at least one processing element and at least one storage element, where the at least one storage element is configured to store a program and data, and the at least one processing element is configured to perform the method provided in the first aspect.

According to a sixth aspect, this application provides a terminal device, including at least one processing element and at least one storage element, where the at least one storage element is configured to store a program and data, and the at least one processing element is configured to perform the method provided in the second aspect.

According to a seventh aspect, this application provides an access network device, including at least one processing element (or chip) configured to perform the method in the first aspect.

According to an eighth aspect, this application provides a terminal device, including at least one processing element (or chip) configured to perform the method in the second aspect.

According to a ninth aspect, this application provides a data transmission program, and when executed by a processor, the program is configured to perform the method in the first aspect.

According to a tenth aspect, this application provides a data transmission program, and when executed by a processor, the program is configured to perform the method in the second aspect.

According to an eleventh aspect, this application provides a program product, for example, a computer readable storage medium, including the program in the ninth aspect.

According to a twelfth aspect, this application provides a program product, for example, a computer readable storage medium, including the program in the tenth aspect.

Compared with the prior art, the access network device sends the first control information to the first terminal device, so that the first terminal device transmits the downlink data received from the access network device, to the second terminal device the plurality of times through the sidelink based on the first control information, thereby increasing the probability of correctly receiving the downlink data by the second terminal device, and the plurality of transmissions through the sidelink is not limited to being affected by the uplink and downlink configuration of the access network device. When the downlink data is downlink URLLC data, the method in this application further improves the reliability of the URLLC data and ensures the low latency requirement of the data transmission in the URLLC scenario.

### BRIEF DESCRIPTION OF DRAWINGS

FIG. 1 is a schematic diagram of transmitting downlink URLLC data a plurality of consecutive times in the prior art according to this application;

FIG. 2 is a schematic architectural diagram of a communications system according to this application;

FIG. 3 is a signaling flowchart of Embodiment 1 of a data transmission method according to this application;

FIG. 4 is a schematic diagram of an uplink and downlink configuration according to this application;

FIG. 5 is a signaling flowchart of Embodiment 2 of a data transmission method according to this application;

FIG. 6 is a schematic structural diagram of Embodiment 1 of an access network device according to this application;

FIG. 7 is a schematic structural diagram of Embodiment 1 of a terminal device according to this application;

FIG. 8 is a schematic structural diagram of Embodiment 2 of an access network device according to this application; and

FIG. 9 is a schematic structural diagram of Embodiment 2 of a terminal device according to the embodiment 2 of this application.

### DESCRIPTION OF EMBODIMENTS

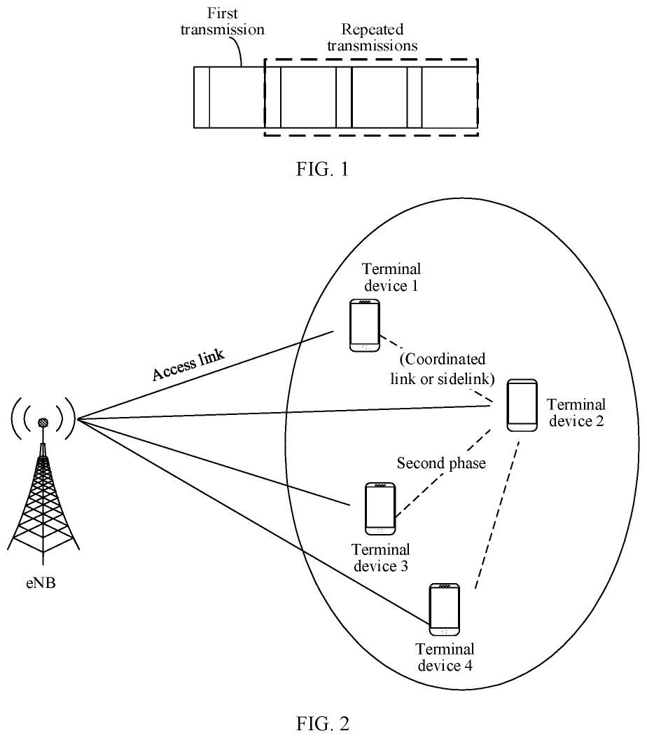

A data transmission method provided in this application may be applicable to a schematic architectural diagram of a communications system shown in FIG. 2. As shown in FIG. 2, the communications system includes an access network device and a plurality of terminal devices. It is assumed that the plurality of terminal devices includes a terminal device 1, a terminal device 2, a terminal device 3, and a terminal device 4 shown in FIG. 2. It should be noted that the communications system shown in FIG. 2 may be applicable to different network standards, for example, may be applicable to network standards such as a global system for mobile communications (GSM), code division multiple access (CDMA), wideband code division multiple access (WCDMA), time division-synchronous code division multiple access (TD-SCDMA), a long term evolution (LTE) system, and future 5G. In one embodiment, the communications system may be a system in a scenario of an ultra-reliable and low latency communications (URLLC) transmission in a 5G communications system.

Therefore, in one embodiment, a base station may be a base transceiver station (BTS) and/or a base station controller in the GSM or the CDMA, a NodeB (NB) and/or a radio network controller (RNC) in the WCDMA, an evolved NodeB (eNB or eNodeB), a relay node, or an access point in the LTE, or a gNB in a 5G network. This is not limited in this application.

The terminal device may be a wireless terminal or a wired terminal. The wireless terminal may refer to a device that provides a user with voice and/or another service data connectivity, a handheld device with a wireless connection function, or another processing device connected to a wireless modem. The wireless terminal may communicate with one or more core network devices through a radio access network (RAN). The wireless terminal may be a mobile terminal, such as a mobile phone (also referred to as a “cellular” phone) and a computer with a mobile terminal, for example, may be a portable, pocket-sized, handheld, computer built-in, or in-vehicle mobile apparatus, which exchanges voice and/or data with the radio access network. For another example, the wireless terminal may alternatively be a device such as a personal communication service (PCS) phone, a cordless telephone set, a session initiation protocol (SIP) phone, a wireless local loop (WLL) station, or a personal digital assistant (PDA). The wireless terminal may alternatively be referred to as a system, a subscriber unit, a subscriber station, a mobile station, a remote station, a remote terminal, an access terminal, a user terminal, a user agent, or a user device (or User Equipment). This application is not limited thereto. In one embodiment, the terminal device may alternatively be a device such as a smartwatch or a tablet.

During communication, the access network device transmits downlink data to the terminal device, where the downlink data is coded through channel coding, and the data obtained after the channel coding is transmitted to the terminal device after constellation modulation; and the terminal device sends uplink data to the access network device, where the uplink data may also be coded through the channel coding, and the data obtained after the coding is transmitted to the base station after the constellation modulation. The plurality of terminal devices may collaborate to communicate with each other.

It should be noted that in the communications system shown in FIG. 2, because some terminal devices are located at an edge of a network coverage area, interference of an ambient environment on a network service is relatively large, and other factors, network quality of service of the terminal devices is relatively poor. For example, the terminal device 2 in FIG. 2 is located at an edge of the network coverage with poorer network quality, and the terminal device 1 is located at a center of the network coverage with better network quality.

Based on the foregoing mentioned URLLC scenario in 5G, low latency and high stability are two most important features of the URLLC. A requirement of the URLLC for stability is 1 to 10⁻⁵, increased a lot compared with 1 to 10⁻² of the LTE. In some application scenarios, a requirement for an end-to-end latency is even less than 1 ms. To make the terminal device 2 still satisfy the requirements for receiving stability and low latency in a case in which the network quality is relatively poor, in the prior art, a solution of transmitting downlink URLLC data a plurality of consecutive times is used. As shown in FIG. 1, the method can increase a probability of receiving the downlink URLLC data by the terminal device 2, and can further reduce a related latency brought by an application HARQ mode by relying on the plurality of transmissions without requiring an acknowledgement ACK or NACK feedback, thereby satisfying the latency requirement of the URLLC scenario. However, when the solution is in a TDD mode, if the access network device sends the downlink URLLC data at the last downlink position (DL slot) of an uplink and downlink configuration, a network side device has only one DL slot for sending the downlink URLLC data, and there is no additional DL slot for transmitting the downlink URLLC data the plurality of consecutive times. Therefore, in this scenario, the solution in the prior art cannot improve the probability of correctly receiving the URLLC data by the terminal device 2. In addition, it should be noted that the “last downlink position (DL slot)” described above refers to the last downlink slot before a downlink is converted to an uplink, namely, the last downlink slot before a special slot, in the uplink and downlink configuration.

The data transmission method provided in this application aims to resolve the foregoing technical problems in the prior art.

The following describes the technical solutions of this application and how the technical solutions of this application resolve the technical problems in detail by using embodiments. The following several embodiments may be combined with each other, and a same or similar concept or process may be not described repeatedly in some embodiments. The following describes the embodiments of this application with reference to accompanying drawings.

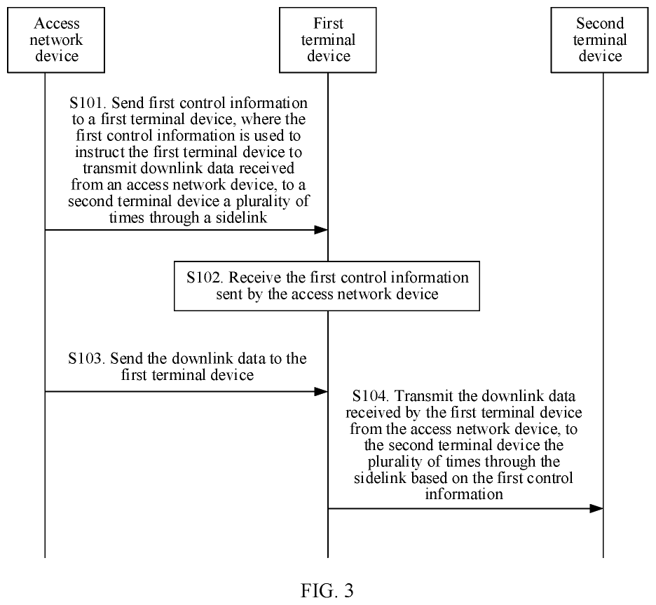

FIG. 3 is a signaling flowchart of Embodiment 1 of a data transmission method according to this application. This embodiment relates to a process in which a first terminal device sends downlink data received from an access network device, to a second terminal device in an device-to-device (D2D) manner a plurality of times, thereby increasing a probability of correctly receiving the downlink data by the second terminal device. The first terminal device and the second terminal device are described before the embodiments are described.

Referring to FIG. 2, it is assumed that the first terminal device is the terminal device 1 and the second terminal device is the terminal device 2. The first terminal device and the second terminal device may constitute a cooperation group. The access network device may configure the first terminal device and the second terminal device to form a cooperation group, or the first terminal device and the second terminal device may form a cooperation group by negotiating with each other through D2D communication interaction between the first terminal device and the second terminal device. In one embodiment, for the cooperation group, each of different cooperation groups in a cell corresponds to one cooperation group identifier, and the cooperation group identifier may be configured by the access network device and is notified to all members in the cooperation group. The access network device may multicast one piece of downlink data by using the cooperation group identifier, and a final destination address of the downlink data is the second terminal device. In one embodiment, the second terminal device is a target user of the downlink data. The following method embodiment mainly relates to a case in which the first terminal device transmits, after receiving the downlink data, the downlink data to the second terminal device through a sidelink a plurality of times, thereby greatly increasing a probability of correctly decoding the data by the second terminal device.

It should be noted that the access network device may or may not configure the cooperation group identifier for the cooperation group. This is not limited in this embodiment.

As shown in FIG. 3, the method includes the following operations.

S101. The access network device sends first control information to the first terminal device, where the first control information is used to instruct the first terminal device to transmit downlink data received from the access network device, to the second terminal device a plurality of times through the sidelink.

In one embodiment, when the downlink data arrives at the access network device, the access network device needs to send the downlink data to the first terminal device. Before sending the downlink data, the access network device needs to send the first control information to the first terminal device, where the first control information is used to instruct the first terminal device to transmit the downlink data received from the access network device, to the second terminal device the plurality of times through the sidelink. In one embodiment, the first control information may include information used to indicate a resource used by the first terminal device to receive the downlink data, and may further include information used to indicate a resource used by the first terminal device to transmit the downlink data to the second terminal device through the sidelink. A form of the first control information is not limited in this embodiment of this application.

In one embodiment, the downlink data sent by the access network device may be downlink URLLC data.

S102. The first terminal device receives the first control information sent by the access network device.

S103. The access network device sends the downlink data to the first terminal device.

S104. The first terminal device transmits, the downlink data received by the first terminal device from the access network device, to the second terminal device a plurality of times through the sidelink based on the first control information.

In one embodiment, after receiving the downlink data sent by the access network device, the first terminal device transmits the received downlink data to the second terminal device a plurality of times through the sidelink based on the first control information. In one embodiment, “the plurality of transmissions” herein may be that the first terminal device transmits downlink data of a same retransmission version to the second terminal device every time, and may alternatively be that the first terminal device transmits downlink data of a different retransmission version to the second terminal device every time, so that the second terminal device can perform a combined process. Based on this, the second terminal device may receive the downlink data transmitted by the first terminal device through the sidelink the plurality of times, thereby improving a probability of correctly decoding the downlink data by the second terminal device. It should be noted that the downlink data mentioned in this application is data sent by the access network device to the terminal device; uplink data is data sent by the terminal device to the access network device; and sidelink data is data sent by the terminal device to the terminal device. The data transmitted by the first terminal device to the second terminal device through the sidelink in this embodiment of this application may actually be referred to as the sidelink data, and content of the sidelink data is essentially content of the downlink data received by the first terminal device from the access network device.

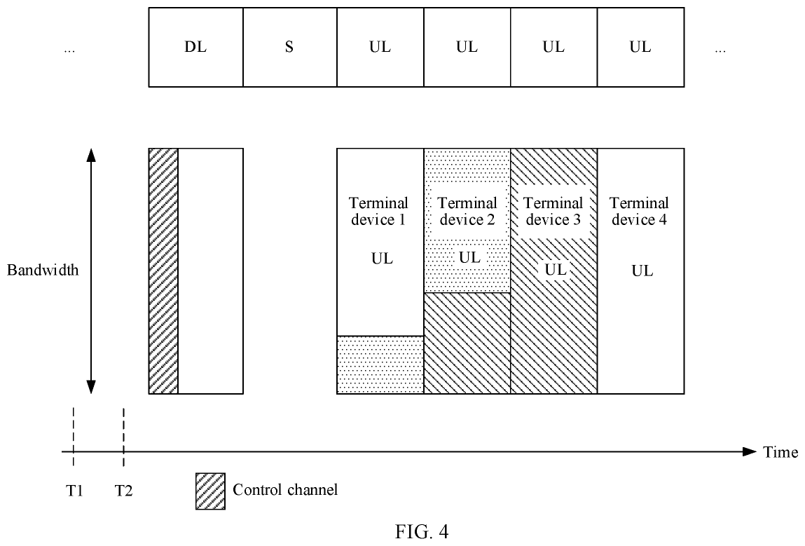

In a TDD mode, for an uplink and downlink configuration scenario shown in FIG. 4: At a moment T1, the access network device determines, based on a service requirement and a scheduling request of the terminal device, an uplink and downlink configuration to be used. For example, referring to an uplink and downlink configuration shown in FIG. 4, it is assumed that the access network device allocates the last DL slot for a downlink transmission of the second terminal device, and it is assumed that four consecutive UL slots after the last DL slot are respectively used for uplink transmissions of the first terminal device (namely, the terminal device 1 in FIG. 2), the second terminal device (namely, the terminal device 2 in FIG. 2), a terminal device 3, and a terminal device 4. In one embodiment, the access network device may schedule any of the terminal devices to perform uplink transmission on the four UL slots, and the terminal device 1, the terminal device 2, the terminal device 3, and the terminal device 4 are merely an example. The access network device may schedule any of the terminal devices to perform uplink transmission on the UL slots.

Continuing to refer to FIG. 4, at a moment T2 (after the moment T1 and before the last DL slot), the downlink data arrives at the access network device. Because the access network device has only the last DL slot left, DL URLLC data cannot be sent to the second terminal device a plurality of times by using a multi-transmission mechanism of a DL URLLC transmission in the prior art, and consequently, a probability of correctly receiving the downlink data by a second terminal device cannot be improved. However, in this application, after receiving the downlink data sent by the access network device, the first terminal device transmits the downlink data to the second terminal device the plurality of times through the sidelink based on the first control information sent by the access network device. The plurality of transmissions herein may use resources of subsequent several UL slots shown in FIG. 4, and when the sidelink data is transmitted, some or all of the resources of the UL slots may be used. Alternatively, the downlink data may be transmitted to the second terminal device through the sidelink the plurality of times by using a new uplink resource that is specially allocated by the access network device for a D2D transmission. In this case, when the sidelink data is transmitted, a part or all of the new uplink resource may be used.

It can be learned from the foregoing descriptions that the data transmission method provided in this application can increase the probability of correctly receiving and decoding the downlink data by the second terminal device in the uplink and downlink configuration scenario shown in FIG. 4. When the downlink data is the downlink URLLC data, the method in this application further improves reliability of the URLLC data and ensures a low latency requirement of a data transmission in a URLLC scenario.

In addition, it should be noted that this embodiment of this application is not only applicable to the scenario, as shown in FIG. 4, in which the access network device sends the downlink data at the last downlink slot after the downlink data arrives, and may further be applicable to the following scenario: The access network device may send the downlink data at any DL slot after the downlink data arrives at the access network device, for example, send the downlink data at the last second downlink slot before a special slot, send the downlink data at the last third downlink slot before a special slot, or the like. In one embodiment, when a quantity of downlink slots or resources corresponding to the downlink slots for sending the downlink data the plurality of times cannot satisfy stability and reliability requirements of the downlink data, the access network device may transmit the downlink data through the sidelink between the first terminal device and the second terminal device the plurality of times by using the solution in this application, to improve the probability of correctly receiving the downlink data by the second terminal device.

In addition, when the quantity of downlink slots or the resources corresponding to the downlink slots for sending the downlink data the plurality of times by the access network device can satisfy the stability and reliability requirements of the downlink data, the access network device may also send the downlink data to the second terminal device through the sidelink the plurality of times by using the first terminal device while transmitting the downlink data to the second terminal device the plurality of times by using the plurality of downlink slots. In the following sending the downlink data a plurality of times, for the downlink data sent by the access network device to the second terminal device the plurality of times and the downlink data sent by the first terminal device to the second terminal device through the sidelink the plurality of times, same sending configuration information and a same time-frequency resource position are used, avoiding generating data interference. This solution is equivalent to that the first terminal device assists the access network device in performing downlink transmission a plurality of times through the plurality of times of sending through the sidelink, and the probability of correctly receiving the downlink data by the second terminal device is further improved by using this solution.

In the data transmission method provided in this application, the access network device sends the first control information to the first terminal device, so that the first terminal device transmits the downlink data received from the access network device, to the second terminal device the plurality of times through the sidelink based on the first control information, thereby increasing the probability of correctly receiving the downlink data by the second terminal device, and the plurality of transmissions through the sidelink is not limited to being affected by an uplink and downlink configuration of the access network device. When the downlink data is the downlink URLLC data, the method in this application further improves reliability of the URLLC data and ensures the low latency requirement of the data transmission in the URLLC scenario.

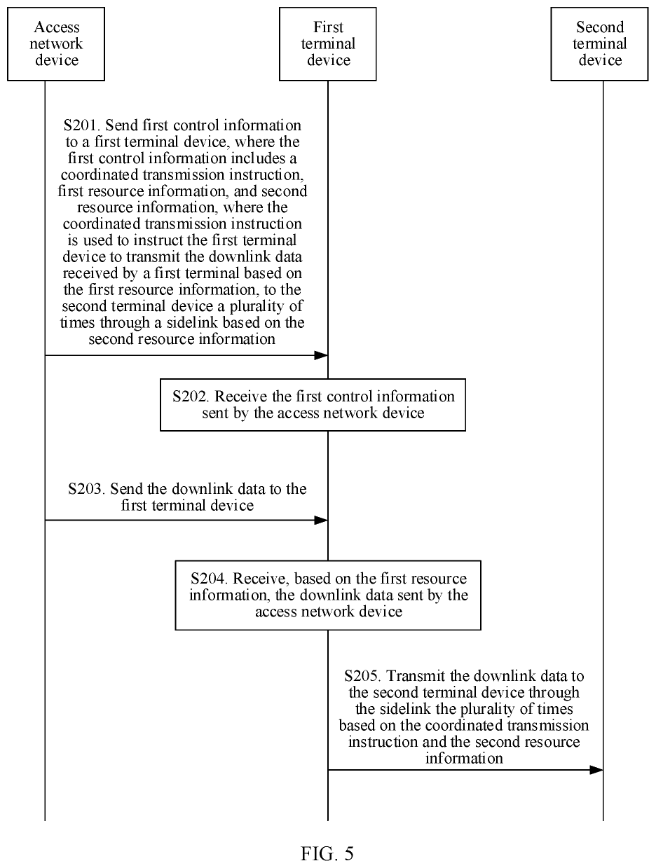

FIG. 5 is a signaling flowchart of Embodiment 2 of a data transmission method according to this application. This embodiment relates to a process of how a first terminal device receives downlink data based on first control information and how the first terminal device transmits the downlink data to a second terminal device based on the first control information a plurality of times.

As shown in FIG. 5, the method may include the following operations.

S201. An access network device sends the first control information to the first terminal device, where the first control information includes a coordinated transmission instruction, first resource information, and second resource information; and the coordinated transmission instruction is used to instruct the first terminal device to transmit the downlink data received by the first terminal device based on the first resource information, to the second terminal device the plurality of times through the sidelink based on the second resource information.

S202. The first terminal device receives the first control information sent by the access network device.

In one embodiment, as described in the foregoing embodiment, the first terminal device and the second terminal device constitute a cooperation group. In this embodiment, the cooperation group may be referred to as a terminal device group. In one embodiment, the access network device may or may not allocate a group identifier for the terminal device group.

After the access network device allocates the group identifier for the terminal device group, the group identifier may be a user equipment cooperation group-radio network temporary identity (UCG-RNTI), and may alternatively be an identifier of another format. This is not limited in this embodiment. When the access network device needs to deliver the first control information, the access network device may bind the group identifier of the terminal device group with downlink control information (DCI), to form first control information and then deliver the first control information to the first terminal device. In one embodiment, the term “bind” herein may be scrambling the DCI by using the group identifier of the terminal device group. In one embodiment, the first control information is the DCI scrambled by the access network device by using the group identifier of the terminal device group, and the DCI may be represented as a DCI format X. When the first terminal device belonging to the terminal device group detects that the identifier of the terminal device group exists in the first control information, the first terminal device receives the first control information, further parses the first control information, and obtains the coordinated transmission instruction, the first resource information, and the second resource information in the first control information.

When the access network device does not allocate the group identifier for the terminal device group and the access network device needs to deliver the first control information, the access network device may bind an identifier of a target user (namely, the second terminal device) of the terminal device group with the DCI, to form the first control information and then deliver the first control information to the first terminal device. In one embodiment, the term “bind” herein may be scrambling the DCI by using the identifier of the second terminal device. In one embodiment, the first control information is the DCI scrambled by the access network device by using the identifier of the second terminal device. When the first terminal device belonging to the terminal device group detects that the identifier of the second terminal device exists in the first control information, the first terminal device receives the first control information, further parses the first control information, and obtains the coordinated transmission instruction, the first resource information, and the second resource information in the first control information.

In one embodiment, the second resource information may include first time-frequency resource configuration information and first transmission configuration information that are used when the first terminal device sends the downlink data to the second terminal device the plurality of times. The first transmission configuration information may include at least one of a modulation and coding scheme (MCS) parameter, antenna configuration information, a quantity of transmissions, and version number-related information for a data retransmission that are used when the first terminal device sends the downlink data to the second terminal device.

In one embodiment, the first resource information may include second time-frequency resource configuration information and second transmission configuration information that are used when the first terminal device receives the downlink data; where the second transmission configuration information may include at least one of a modulation and coding scheme (MCS) parameter and antenna configuration information that are used when the first terminal device receives the downlink data.

S203. The access network device sends the downlink data to the first terminal device.

S204. The first terminal device receives, based on the first resource information, the downlink data sent by the access network device.

S205. The first terminal device transmits the downlink data to the second terminal device through the sidelink the plurality of times based on the coordinated transmission instruction and the second resource information.

In one embodiment, after the first terminal device parses and obtains the coordinated transmission instruction, the first resource information, and the second resource information in the first control information, the first terminal device is aware, by using the coordinated transmission instruction, that the first terminal device needs to transmit the received downlink data to the second terminal device through the sidelink the plurality of times.

Therefore, after the access network device sends the downlink data to the first terminal device, the first terminal device may receive the downlink data based on content of the first resource information at a corresponding time-frequency resource position, and then transmit the received downlink data to the second terminal device the plurality of times through the sidelink based on the coordinated transmission instruction and content of the second resource information.

In one embodiment, the access network device may form the second resource information based on a new uplink resource allocated by the access network device for the second terminal device, and the new uplink resource is different from an uplink resource that has been scheduled by the access network device. In one embodiment, a time-frequency resource indicated by the first time-frequency resource configuration information in the second resource information may be a new uplink resource allocated by the access network device, and the first terminal device may send the downlink data to the second terminal device through the sidelink the plurality of times by using the new uplink resource. In this method, because the access network device allocates the new uplink resource for the transmission through the sidelink, the access network device does not need to cancel uplink scheduling of another terminal device.

In one embodiment, the access network device may alternatively form the second resource information based on a to-be-cancelled uplink scheduling resource. In one embodiment, after the access network device cancels the to-be-cancelled uplink scheduling resource, a part or all of the cancelled uplink scheduling resource is used for the transmission through the sidelink between the first terminal device and the second terminal device. In one embodiment, after the access network device cancels uplink scheduling resources of some (one or more) terminal devices covered by the access network device, the access network device may send the second control information to the terminal devices covered by the access network device. The second control information carries an uplink scheduling cancellation instruction, to notify the terminal devices that the access network device has cancelled the uplink scheduling resources of the terminal devices. It should be noted that when the first terminal device sends sidelink data to the second terminal device, because the access network device has used an uplink resource to schedule a terminal for performing uplink transmission, at least a part of the uplink scheduling resource needs to be cancelled and used as a sidelink scheduling resource for sidelink communication between the first terminal device and the second terminal device, and the at least a part of the uplink scheduling resource that needs to be cancelled is referred to as the “to-be-cancelled uplink scheduling resource” in this application.

In one embodiment, when the access network device allocates the group identifier for the terminal device group in which the first terminal device and the second terminal device are located, if the access network device cancels an uplink scheduling resource of a member in the terminal device group, the access network device may bind the group identifier of the terminal device group with DCI (the DCI may be represented as a DCI format Y, and the DCI format Y is different from the DCI format X), to form the second control information and then deliver the second control information. In one embodiment, the term “bind” herein may be scrambling the DCI format Y by using the group identifier of the terminal device group. In one embodiment, the second control information is the DCI scrambled by the access network device by using the group identifier of the terminal device group. When the member of the terminal device group detects that the identifier of the terminal device group exists in the second control information, the member of the terminal device group receives the second control information, further parses the second control information, and obtains the uplink scheduling cancellation instruction. It should be noted that when the second control information is scrambled by using the group identifier of the terminal device group, only the member in the terminal device group can receive the second control information, and further learns that the access network device cancels the uplink scheduling resource of the member in the terminal device group.

In one embodiment, when the access network device does not allocate the group identifier for the terminal device group in which the first terminal device and the second terminal device are located, if the access network device cancels uplink scheduling resources of some terminal devices, the access network device may bind an identifier of each terminal device in the some terminal devices with the DCI format Y, to obtain a plurality of pieces of second control information and send the plurality of pieces of second control information to the terminal device covered by the access network device. When the terminal device detects that the second control information carries an identifier of the terminal device, the terminal device receives the second control information and parses the second control information, so that the terminal device learns that the access network device cancels the uplink scheduling resource of the terminal device according to an uplink scheduling cancellation instruction in the second control information. In one embodiment, the identifier of the terminal device may be a radio network temporary identity (RNTI) of the terminal device. In one embodiment, an identifier of a terminal device that the access network device adds to the delivered one or more pieces of second control information indicates that an uplink scheduling resource of the terminal device is cancelled by the access network device.

It should be noted that the some terminal devices covered by the access network device may be the first terminal device, all the terminal devices in the terminal device group, or may be a terminal device in a non-terminal device group. That the access network device sends the second control information may include two cases.

In a first case, assuming that the access network device performs uplink scheduling for only the first terminal device (and in one embodiment, allocates an uplink scheduling resource for only the first terminal device and allocates no uplink scheduling resource for another terminal device), the first terminal device is used as a device for assisting the second terminal device in improving a probability of correctly receiving the downlink data (and in one embodiment, the first terminal device may be considered as a cooperation user). After receiving the downlink data based on the first resource information, the first terminal device learns that the first terminal device is a user assisting the second terminal device. When the uplink scheduling resource of the first terminal device is sufficient for performing transmission a plurality of times, the first terminal device may transmit the downlink data to the second terminal device through the sidelink the plurality of times by directly using the uplink scheduling resource of the first terminal device. In this case, the access network device does not need to send the second control information to the first terminal device.

In a second case, referring to FIG. 2, assuming that the access network device not only performs uplink scheduling for the first terminal device (a terminal device 1), but also performs uplink scheduling for the second terminal device (a terminal device 2) and a terminal device 3, the first terminal device is used as a device for assisting the second terminal device in improving a probability of correctly receiving the downlink data (and in one embodiment, the first terminal device may be considered as a cooperation user). After receiving the downlink data based on the first resource information, the first terminal device learns that the first terminal device is a user assisting the second terminal device. When an uplink scheduling resource of the first terminal device is insufficient for performing transmission a plurality of times, the access network device needs to cancel uplink scheduling resources of the terminal device 2 and the terminal device 3, then combines the uplink scheduling resources of the terminal device 1, the terminal device 2, and the terminal device 3 together, to form a total uplink scheduling resource, and then uses a part or all of the total uplink scheduling resource as a resource for a sidelink transmission. In this case, the access network device needs to separately send the second control information to the terminal device 2 and the terminal device 3, to notify the terminal device 2 and the terminal device 3 that the access network device cancels the uplink scheduling resources of the terminal device 2 and the terminal device 3. In one embodiment, the second control information sent to the terminal device 2 may be a DCI format Y scrambled by using the group identifier of the terminal device group, or may be a DCI format Y scrambled by using an identifier of the terminal device. The second control information sent to the terminal device 3 may be a DCI format Y scrambled by using an identifier of the terminal device 3.

It can be learned from the foregoing descriptions that, the access network device may form the second resource information by allocating the new uplink resource for the data transmission through the sidelink, to assist the first terminal device in transmitting the received downlink data to the second terminal device the plurality of times. The access network device may alternatively cancel an uplink scheduling resource that has been scheduled and that is of the terminal device, and use the cancelled uplink scheduling resource as a resource of the data transmission through the sidelink, to assist the first terminal device in transmitting the received downlink data to the second terminal device the plurality of times. Therefore, the method provided in this application can be not limited to being affected by an uplink and downlink configuration used by the access network device, and can increase the probability of correctly receiving the downlink data by the second terminal device, improve network quality of service of the second terminal device, and ensure stability and reliability of the data transmission.

In addition, it should be noted that the cancelled uplink scheduling resource in this embodiment of this application may be not only used for a sidelink transmission, but may also be used for a downlink transmission.

To describe this application more clearly, the following describes a process in this embodiment of this application by using a simple example.

In this example, assuming that the access network device performs uplink scheduling for the terminal device 1, the terminal device 2, and the terminal device 3, the terminal device 1 and the terminal device 2 constitute a terminal device group, and the access network device allocates the group identifier for the terminal device group. With reference to the uplink and downlink configuration scenario shown in FIG. 4, three slots after a special slot are all uplink slots (UL slot). The downlink data arrives at the access network device before the last downlink slot (DL slot) (namely, a moment T1 in FIG. 4) before the special slot (S), and the access network device sends the downlink data on the last DL slot. Before sending the downlink data, the access network device needs to send the first control information to the first terminal device, where the first control information includes a coordinated transmission instruction, first resource information, and second resource information. The terminal device 2 is a user with poor network quality of service and is referred to as a target user. The terminal device 1 is a user with good network quality of service, and is referred to as a cooperation user.

When detecting that the group identifier of the terminal device group or the identifier of the terminal device 2 exists in the first control information, the terminal device 1 determines to receive the first control information, and then obtains the coordinated transmission instruction, the first resource information, and the second resource information in the first control information. The terminal device 1 receives, by using the first resource information, the downlink data sent by the access network device, and learns, according to the coordinated transmission instruction, that the terminal device 1 needs to transmit the received downlink data to the terminal device 2 a plurality of times. Then the terminal device 1 transmits, by using content indicated by the second resource information, the downlink data to the terminal device 2 through the sidelink the plurality of times at a specified time-frequency resource position based on specified transmission configuration information. In addition, because the terminal device 1 learns that the terminal device 1 needs to perform sidelink transmission, the terminal device 1 does not perform sending on a corresponding uplink scheduling resource, so that the terminal device 1 may perform sidelink transmission or D2D transmission by using the uplink scheduling resource. A time-frequency resource indicated by the first time-frequency resource configuration information in the second resource information includes the uplink scheduling resource of the terminal device 1.

When detecting that the group identifier of the terminal device group or the identifier of the terminal device 2 exists in the first control information, the terminal device 2 determines to receive the first control information, and then obtains the coordinated transmission instruction, the first resource information, and the second resource information in the first control information. The terminal device 2 learns, according to the coordinated transmission instruction, that the terminal device 1 needs to transmit the downlink data to the terminal device 2 the plurality of times, and then the terminal device 2 receives, based on the content of the second resource information, the downlink data the plurality of times at the specified time-frequency resource position based on the specified transmission configuration information. In addition, the terminal device 2 may further receive the second control information by detecting the identifier of the terminal device 2 or the identifier of the terminal device group, and learns, according to an uplink scheduling cancellation instruction in the second control information, that the access network device has cancelled the uplink scheduling for the terminal device 2. The terminal device 2 does not perform uplink sending on the uplink scheduling resource any more. The time-frequency resource indicated by the first time-frequency resource configuration information in the second resource information further includes the cancelled uplink scheduling resource of the terminal device 2.

Similarly, because the first control information is not bound with the identifier of the terminal device 3, the terminal device 3 does not need to receive the first control information. However, because the access network device cancels the uplink scheduling resource of the terminal device 3, the terminal device 3 determines, by detecting the identifier of the terminal device 3, to receive the second control information bound with the identifier of the terminal device 3, and then the terminal device 3 learns, according to the uplink scheduling cancellation instruction in the second control information, that the access network device has cancelled the uplink scheduling for the terminal device 3. The terminal device 3 does not perform uplink sending on the cancelled uplink scheduling resource any more. Therefore, the time-frequency resource indicated by the first time-frequency resource configuration information in the second resource information may further include the cancelled uplink scheduling resource of the terminal device 3.

Based on this, the access network device prepares the uplink scheduling resources of the terminal device 1, the terminal device 2, and the terminal device 3 for a sidelink transmission, then the terminal device 1 may transmit, by using the uplink scheduling resources, the downlink data to the second terminal device through the sidelink the plurality of times, greatly increasing the probability of correctly receiving the downlink data by the second terminal device. In addition, this application is not limited to being affected by the uplink and downlink configuration used by the access network device, ensuring the stability and the reliability of the data transmission.

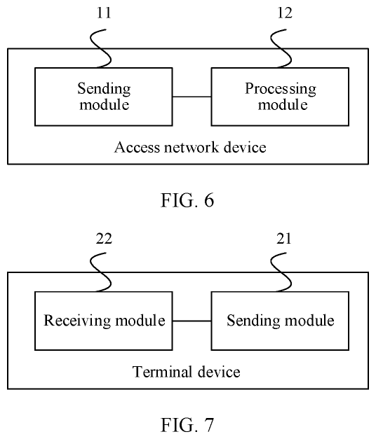

FIG. 6 is a schematic structural diagram of Embodiment 1 of an access network device according to this application. As shown in FIG. 6, the access network device includes a sending module 11 and a processing module 12.

In one embodiment, the sending module 11 is configured to send first control information to a first terminal device and send downlink data to the first terminal device, where the first control information is used to instruct the first terminal device to transmit the downlink data received from the access network device, to a second terminal device a plurality of times through a sidelink.

In one embodiment, the first control information includes a coordinated transmission instruction, first resource information, and second resource information; and

the coordinated transmission instruction is used to instruct the first terminal device to transmit the downlink data received by the first terminal device based on the first resource information, to the second terminal device the plurality of times through the sidelink based on the second resource information.

In one embodiment, the processing module 12 is configured to form the second resource information based on a to-be-cancelled uplink scheduling resource.

In one embodiment, the sending module 11 is further configured to send second control information to a terminal device in a coverage area of the access network device, where the second control information carries an uplink scheduling cancellation instruction, and the uplink scheduling cancellation instruction is used to instruct the access network device to cancel the uplink scheduling resource of the terminal device.

In one embodiment, the processing module 12 may alternatively be configured to form the second resource information based on a new uplink resource allocated by the access network device for the second terminal device, and the new uplink resource is different from an uplink resource that has been scheduled by the access network device.

Further, the first control information is downlink control information (DCI) scrambled by the access network device by using a group identifier of a terminal device group or an identifier of the second terminal device; and the terminal device group includes the first terminal device and the second terminal device.

Further, the second control information is downlink control information DCI scrambled by the access network device by using a group identifier of a terminal device group or an identifier of the terminal device; and the terminal device group includes the first terminal device and the second terminal device.

In one embodiment, the second resource information includes first time-frequency resource configuration information and first transmission configuration information that are used when the first terminal device sends the downlink data to the second terminal device the plurality of times; and

the first transmission configuration information includes at least one of a modulation and coding scheme (MCS) parameter, antenna configuration information, a quantity of transmissions, and version number-related information for a data retransmission that are used when the first terminal device sends the downlink data to the second terminal device.

In one embodiment, the first resource information includes second time-frequency resource configuration information and second transmission configuration information that are used when the first terminal device receives the downlink data; and

the second transmission configuration information includes at least one of a modulation and coding scheme (MCS) parameter and antenna configuration information that are used when the first terminal device receives the downlink data.

The access network device provided in this application may perform the foregoing method embodiment. Their implementation principles and technical effects are similar, and details are not described herein again.

FIG. 7 is a schematic structural diagram of Embodiment 1 of a terminal device according to this application; The terminal device may be the first terminal device in the method embodiment. As shown in FIG. 7, the first terminal device includes a receiving module 22 and a sending module 21.

In one embodiment, the receiving module 22 is configured to receive first control information sent by an access network device; and

the sending module 21 is configured to transmit downlink data received by the receiving module 22 from the access network device, to a second terminal device a plurality of times through a sidelink based on the first control information.

In one embodiment, the first control information includes a coordinated transmission instruction, first resource information, and second resource information;

the receiving module 22 is further configured to receive, based on the first resource information, the downlink data sent by the access network device; and

the sending module 21 is configured to transmit, based on the coordinated transmission instruction and the second resource information, the downlink data to the second terminal device through the sidelink the plurality of times.

In one embodiment, the second resource information is information formed by the access network device based on a to-be-cancelled uplink scheduling resource.

In one embodiment, the second resource information is information formed by the access network device based on a new uplink resource allocated by the access network device for the second terminal device, and the new uplink resource is different from an uplink resource that has been scheduled by the access network device.

In one embodiment, the second resource information includes first time-frequency resource configuration information and first transmission configuration information that are used when the sending module 21 sends the downlink data to the second terminal device the plurality of times; and

the first transmission configuration information includes at least one of a modulation and coding scheme (MCS) parameter, antenna configuration information, a quantity of transmissions, and version number-related information for a data retransmission that are used when the sending module 21 sends the downlink data to the second terminal device.

In one embodiment, the first resource information includes second time-frequency resource configuration information and second transmission configuration information that are used when the receiving module 22 receives the downlink data; and

the second transmission configuration information includes at least one of a modulation and coding scheme (MCS) related parameter and antenna configuration information that are used when the receiving module 22 receives the downlink data.

The terminal device provided in this application may perform the foregoing method embodiment, and their implementation principles and technical effects are similar, and details are not described herein again.

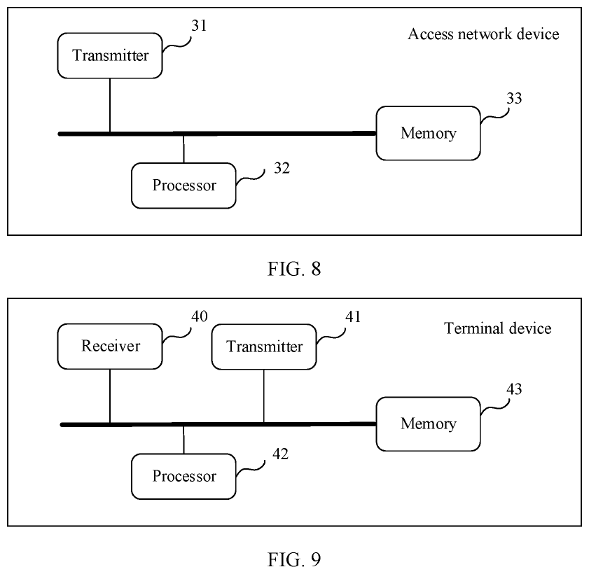

FIG. 8 is a schematic structural diagram of Embodiment 2 of an access network device according to this application. As shown in FIG. 8, the access network device may include a transmitter 31, a processor 32, and a memory 33. The memory 33 may include a high-speed RAM memory, and may further include a non-volatile memory (NVM), for example, at least one magnetic disk storage. The memory 33 may store various programs, to complete various processing functions and implement method operations in this embodiment. In one embodiment, the transmitter 31 in this embodiment may be a radio frequency module or a baseband module on the access network device.

In this embodiment, the transmitter 31 is configured to send first control information to a first terminal device and send downlink data to the first terminal device, where the first control information is used to instruct the first terminal device to transmit the downlink data received from the access network device, to a second terminal device a plurality of times through a sidelink.

In one embodiment, the first control information includes a coordinated transmission instruction, first resource information, and second resource information; and

the coordinated transmission instruction is used to instruct the first terminal device to transmit the downlink data received by the first terminal device based on the first resource information, to the second terminal device the plurality of times through the sidelink based on the second resource information.

In one embodiment, the processor 32 is configured to form the second resource information based on a to-be-cancelled uplink scheduling resource.

In one embodiment, the transmitter 31 is further configured to send second control information to a terminal device in a coverage area of the access network device, where the second control information carries an uplink scheduling cancellation instruction, and the uplink scheduling cancellation instruction is used to instruct the access network device to cancel the uplink scheduling resource of the terminal device.

In one embodiment, the processor 32 may alternatively be configured to form the second resource information based on a new uplink resource allocated by the access network device for the second terminal device, and the new uplink resource is different from an uplink resource that has been scheduled by the access network device.

Further, the first control information is downlink control information (DCI) scrambled by the access network device by using a group identifier of a terminal device group or an identifier of the second terminal device; and the terminal device group includes the first terminal device and the second terminal device.

Further, the second control information is downlink control information DCI scrambled by the access network device by using a group identifier of a terminal device group or an identifier of the terminal device; and the terminal device group includes the first terminal device and the second terminal device.

In one embodiment, the second resource information includes first time-frequency resource configuration information and first transmission configuration information that are used when the first terminal device sends the downlink data to the second terminal device the plurality of times; and

the first transmission configuration information includes at least one of a modulation and coding scheme MCS parameter, antenna configuration information, a quantity of transmissions, and version number-related information for a data retransmission that are used when the first terminal device sends the downlink data to the second terminal device.

In one embodiment, the first resource information includes second time-frequency resource configuration information and second transmission configuration information that are used when the first terminal device receives the downlink data; and

the second transmission configuration information includes at least one of a modulation and coding scheme (MCS) parameter and antenna configuration information that are used when the first terminal device receives the downlink data.

The access network device provided in this application may perform the foregoing method embodiment. Their implementation principles and technical effects are similar, and details are not described herein again.

FIG. 9 is a schematic structural diagram of Embodiment 2 of a terminal device according to this application. As shown in FIG. 9, the terminal device may be the first terminal device in the method embodiment. The terminal device may include a receiver 40, a transmitter 41, a processor 42, and a memory 43. The memory 43 may include a high-speed RAM memory, and may further include a non-volatile memory (NVM), for example, at least one magnetic disk storage. The memory 43 may store various programs, to complete various processing functions and implement method operations in this embodiment. In one embodiment, the receiver 40 and the transmitter 41 in this embodiment may be a radio frequency module or a baseband module on the terminal device. The receiver 40 and the transmitter 41 may be integrated to form a transceiver.

In this embodiment, the receiver 40 is configured to receive first control information sent by an access network device; and

the transmitter 41 is configured to transmit downlink data received by the receiver 40 from the access network device, to a second terminal device through a sidelink a plurality of times based on the first control information.

In one embodiment, the first control information includes a coordinated transmission instruction, first resource information, and second resource information; and

the receiver 40 is further configured to receive, based on the first resource information, the downlink data sent by the access network device; and

the transmitter 41 is configured to transmit the downlink data to the second terminal device through the sidelink the plurality of times based on the coordinated transmission instruction and the second resource information.

In one embodiment, the second resource information is information formed by the access network device based on a to-be-cancelled uplink scheduling resource.

In one embodiment, the second resource information is information formed by the access network device based on a new uplink resource allocated by the access network device for the second terminal device, and the new uplink resource is different from an uplink resource that has been scheduled by the access network device.

In one embodiment, the second resource information includes first time-frequency resource configuration information and first transmission configuration information that are used when the transmitter 41 sends the downlink data to the second terminal device the plurality of times; and

the first transmission configuration information includes at least one of a modulation and coding scheme (MCS) parameter, antenna configuration information, a quantity of transmissions, and version number-related information for a data retransmission that are used when the transmitter 41 sends the downlink data to the second terminal device.

In one embodiment, the first resource information includes second time-frequency resource configuration information and second transmission configuration information that are used when the receiver 40 receives the downlink data; and

the second transmission configuration information includes at least one of a modulation and coding scheme (MCS) related parameter and antenna configuration information that are used when the receiver 40 receives the downlink data.

The terminal device provided in this application may perform the foregoing method embodiment, and their implementation principles and technical effects are similar, and details are not described herein again.

What is claimed is:

1. A data transmission method comprising:
sending, by an access network device, first control information to a first terminal device, wherein the first control information instructs the first terminal device to transmit downlink data received from the access network device to a second terminal device a plurality of times through a sidelink; and
sending, by the access network device, the downlink data to the first terminal device.

2. The method according to claim 1, wherein the first control information comprises a coordinated transmission instruction, first resource information, and second resource information; and
the coordinated transmission instruction is used to instruct the first terminal device to transmit the downlink data received by the first terminal device based on the first resource information to the second terminal device the plurality of times through the sidelink based on the second resource information.

3. The method according to claim 2, further comprising:
forming, by the access network device, the second resource information based on a to-be-cancelled uplink scheduling resource.

4. The method according to claim 3, further comprising:
sending, by the access network device, second control information to a terminal device in a coverage area of the access network device, wherein the second control information carries an uplink scheduling cancellation instruction, and the uplink scheduling cancellation instruction is used to instruct the access network device to cancel the to-be-cancelled uplink scheduling resource of the terminal device.

5. The method according to claim 2, further comprising:
forming, by the access network device, the second resource information based on a new uplink resource allocated by the access network device for the second terminal device, wherein the new uplink resource is different from an uplink resource scheduled by the access network device.

6. The method according to claim 4, wherein the second control information is downlink control information (DCI) scrambled by the access network device by using a group identifier of a terminal device group or an identifier of the terminal device; and the terminal device group comprises the first terminal device and the second terminal device.

7. A data transmission method comprising:
receiving, by a first terminal device, first control information sent by an access network device; and
transmitting, by the first terminal device, downlink data received by the first terminal device from the access network device to a second terminal device a plurality of times through a sidelink based on the first control information.

8. The method according to claim 7, wherein the first control information comprises a coordinated transmission instruction, first resource information, and second resource information; and the transmitting, by the first terminal device, downlink data received by the first terminal device from the access network device to a second terminal device a plurality of times through a sidelink based on the first control information comprises:
receiving, by the first terminal device based on the first resource information, the downlink data sent by the access network device; and
transmitting, by the first terminal device based on the coordinated transmission instruction and the second resource information, the downlink data to the second terminal device through the sidelink the plurality of times.

9. The method according to claim 8, wherein the second resource information is information formed by the access network device based on a to-be-cancelled uplink scheduling resource.

10. The method according to claim 8, wherein the second resource information is information formed by the access network device based on a new uplink resource allocated by the access network device for the second terminal device, and the new uplink resource is different from an uplink resource scheduled by the access network device.

11. An access network device comprising:
a sending module configured to send first control information to a first terminal device and send downlink data to the first terminal device, wherein
the first control information instructs the first terminal device to transmit the downlink data received from the access network device to a second terminal device a plurality of times through a sidelink.

12. The access network device according to claim 11, wherein the first control information comprises a coordinated transmission instruction, first resource information, and second resource information; and
the coordinated transmission instruction is used to instruct the first terminal device to transmit the downlink data received by the first terminal device based on the first resource information to the second terminal device the plurality of times through the sidelink based on the second resource information.

13. The access network device according to claim 12, wherein the access network device further comprises a processing module, and
the processing module is configured to form the second resource information based on a to-be-cancelled uplink scheduling resource.

14. The access network device according to claim 13, wherein the sending module is further configured to send second control information to a terminal device in a coverage area of the access network device, wherein the second control information carries an uplink scheduling cancellation instruction, and the uplink scheduling cancellation instruction is used to instruct the access network device to cancel the to-be-cancelled uplink scheduling resource of the terminal device.

15. The access network device according to claim 12, wherein the access network device further comprises a processing module, and
the processing module is configured to form the second resource information based on a new uplink resource allocated by the access network device for the second terminal device, wherein the new uplink resource is different from an uplink resource scheduled by the access network device.

16. The access network device according to claim 14, wherein the second control information is downlink control information (DCI) scrambled by the access network device by using a group identifier of a terminal device group or an identifier of the terminal device; and the terminal device group comprises the first terminal device and the second terminal device.

17. A first terminal device comprising:
a receiving module configured to receive first control information sent by an access network device; and
a sending module configured to transmit downlink data received by the receiving module from the access network device to a second terminal device a plurality of times through a sidelink based on the first control information.

18. The first terminal device according to claim 17, wherein the first control information comprises a coordinated transmission instruction, first resource information, and second resource information, wherein
the receiving module is further configured to receive, based on the first resource information, the downlink data sent by the access network device; and
the sending module is configured to transmit, based on the coordinated transmission instruction and the second resource information, the downlink data to the second terminal device through the sidelink the plurality of times.

19. The first terminal device according to claim 18, wherein the second resource information is information formed by the access network device based on a to-be-cancelled uplink scheduling resource.

20. The first terminal device according to claim 18, wherein the second resource information is information formed by the access network device based on a new uplink resource allocated by the access network device for the second terminal device, and the new uplink resource is different from an uplink resource scheduled by the access network device.
